(19) United States
(12) Patent Application Publication
(10) Pub. No.: US 2018/0231314 A1
(43) Pub. Date: Aug. 16, 2018

(54) BURNER TUBE INSERT

(71) Applicant: Honda Motor Co., Ltd., Tokyo (JP)

(72) Inventors: Michael Edward Devine, II, Bellefontaine, OH (US); Steven Ray Pope, II, Bellefontaine, OH (US)

(21) Appl. No.: 15/432,738

(22) Filed: Feb. 14, 2017

(51) Int. Cl. F27B 14/14

(52) U.S. Cl. CPC F27B 14/14; F27B 2014/0843

(57) ABSTRACT

A furnace melt tower includes a burner block having an inner wall defining a burner port for receiving a burner nozzle and a burner tube insert received within the burner port between the inner wall and the burner nozzle to protect the burner port and ease cleaning and repair. The burner tube insert includes a cylindrical body having a first end and a second end and a flange extending radially outward from the first end of the burner tube insert.

### TECHNICAL FIELD

The embodiments disclosed herein relate to the field of melt furnaces, and more particularly burners for melt furnaces.

### BACKGROUND

A melt furnace for melting scrap metal includes a burner opening in a side wall of the furnace. Furnace melt towers may not melt the scrap as designed and required due to excessive wear of the burner opening, which is also referred to as a burner block. Replacement or patching of the burner block while the furnace wall is hot is not possible. Therefore, there exists a need for a way to reline the burner block to a like-new condition with the inner wall being hot. Additionally, a need exists to restore the burner block quickly, in as few as five minutes. Further, there is a need for a way to maintain a burner block in a new condition with limited wear that can be cleaned without excessive force.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a furnace melt tower includes a burner block having an inner wall defining a burner port for receiving a burner nozzle, and a burner tube insert received within the burner port between the inner wall and the burner nozzle.

According to another aspect, a burner tube insert for use with a port in a burner block of a furnace melt tower includes a cylindrical body having a first end and a second end and a flange extending radially outward from the first end of the burner tube insert, the flange having a first surface and a second surface.

According to yet another aspect, a burner assembly for a furnace includes a burner block having an inner wall defining a burner port, a burner nozzle disposed within the burner port, and a burner tube insert received within the burner port between the inner wall and the burner nozzle.

### BRIEF DESCRIPTION OF THE DRAWINGS

FIG. 1 is a schematic view of a furnace with a melting tower.

FIG. 2 is a side view of a burner tube insert.

FIG. 3 is a top view of the burner tube insert of FIG. 2.

FIG. 4 is a side view of the burner tube insert installed in a burner block of the furnace with the melting tower of FIG. 1.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

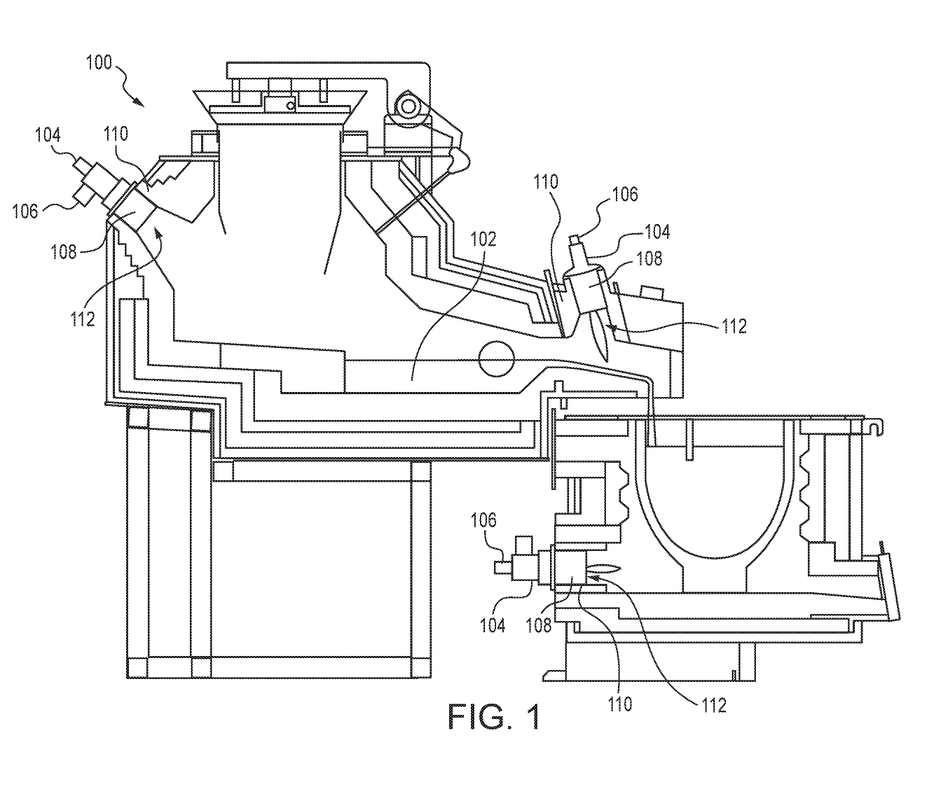

FIG. 1 illustrates one embodiment of a furnace melt tower 100. The furnace melt tower 100 is used to melt down scrap metal 102 to be recycled or repurposed. The furnace melt tower 100 uses burners 104 to heat the scrap metal 102. Each of the burners 104 includes a burner body 106 and a burner nozzle 108 that extends from the burner body 106. The burner nozzle 108 is inserted into a burner block 110, which is a portion of the furnace melt tower 100 that includes a burner port 112 into which the burner nozzle 108 is inserted.

The inner walls of the burner port 112 in the burner block 110 may become damaged under the heating and cooling conditions associated with operation of the burner 104. Further, the inner walls of the burner port 112 may become encrusted with burnt fuel residue, and scraps, which may impact the performance of the burners 104 by limiting air flow or closing the burner port 112 if residue is allowed to build up over time. In the embodiment described herein, the residue may consist of byproducts of combustion of natural gas, which is the fuel used by the burners 104, as well as impurities that may be introduced into the burner block 110. The difficulty with residue is that it cannot be removed when the furnace melt tower 100 is in use, or for a significant amount of time after use until the burner block 110 cools down from operating temperatures of the furnace melt tower 100. Further, in a cooled state, the residue buildup often requires a jackhammer or hammer and chisel to remove, which may damage the inner walls of the burner block 110.

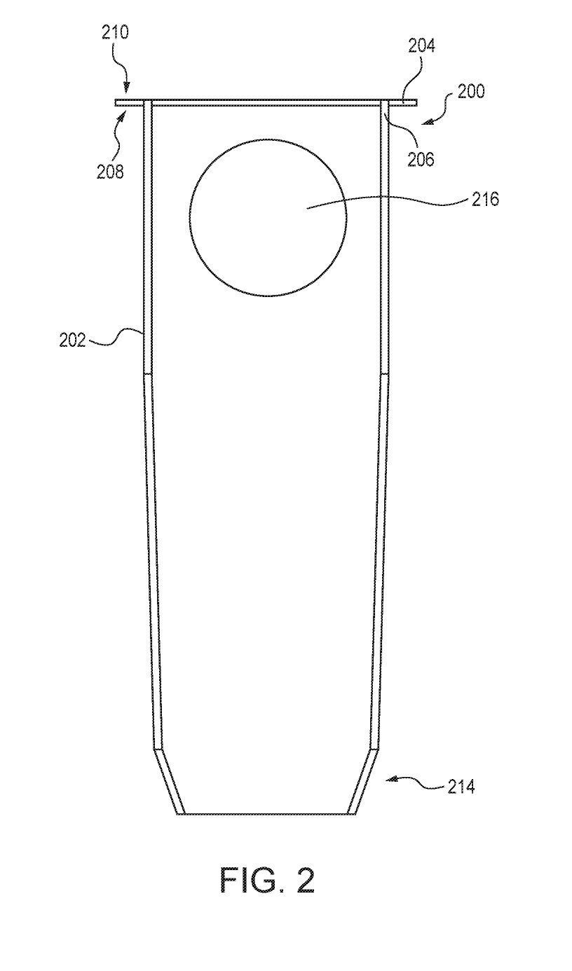

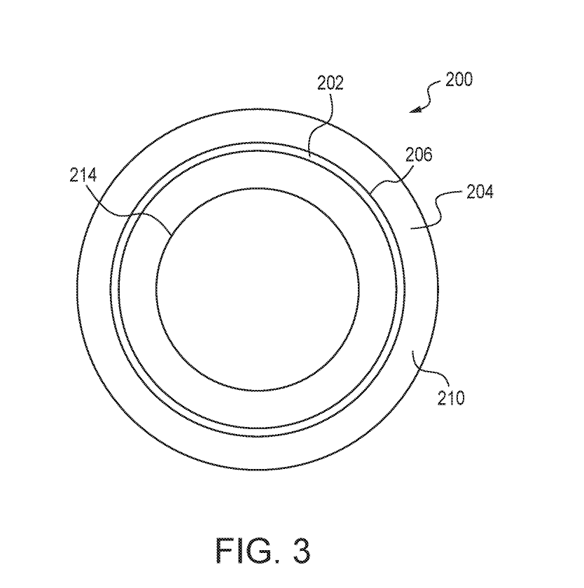

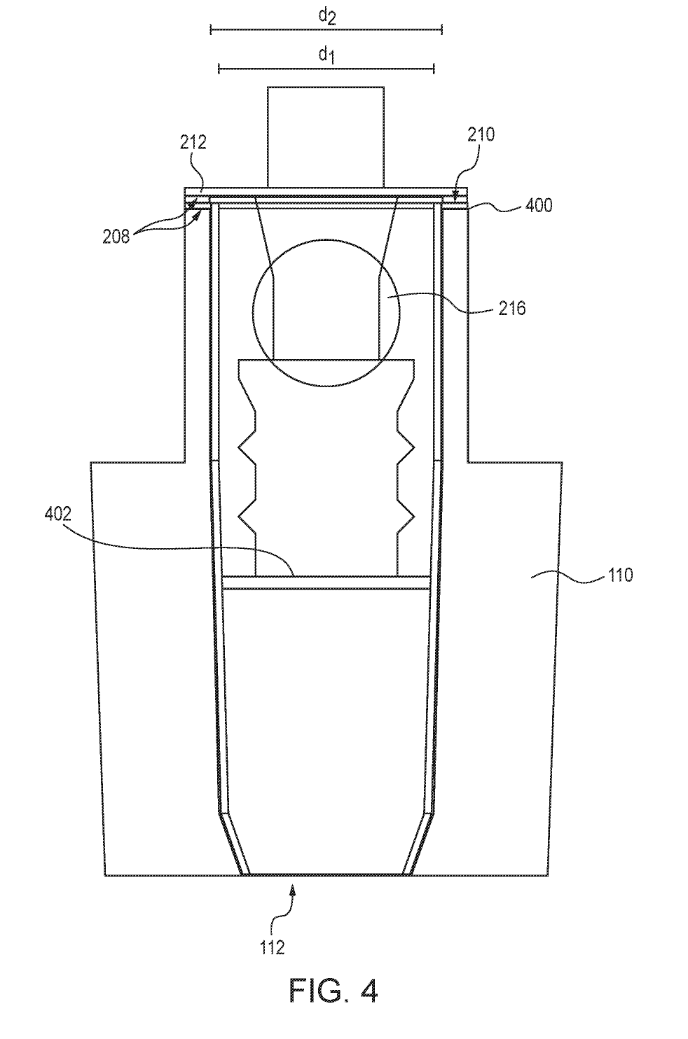

FIGS. 2-4 illustrate an embodiment of a burner tube insert 200 that may be used as a liner that is slid into the burner port 112 to restore the shape of the burner port 112. The burner tube insert 200 may include a cylindrical body 202 with a slightly smaller outer diameter d₁ than an inner diameter d₂ of the burner port 112 in the burner block 110, as illustrated in FIG. 4. The burner tube insert 200 is mounted inside the burner block 110 and held in place with a flange 204 that extends radially outward from a first end 206 of the cylindrical body 202. One surface 208 of the flange 204 abuts against the outer wall 400 of the burner block 110, and the second surface 210 of the flange 204 is abutted by a shoulder 212 on the burner nozzle 108. The second end 214 of the cylindrical body 202 may have a generally frustoconical shape to match that of the burner port 112 in the burner block 110 to ensure proper operation of the burner nozzle 108. The cylindrical body 202 may also include at least one port 216 cut or formed within the cylindrical body 202 to allow air and gas flow as necessary to facilitate proper combustion at the end 402 of the burner nozzle 108 and to generate a flame of the desired shape in the burner tube insert 200.

The burner tube insert 200 may be constructed from mild steel or stainless steel to help maintain a proper shape under extreme heat conditions. In the embodiment described herein, the set point operating temperature of the furnace melt tower 100 is 1250° F., and the furnace melt tower 100 typically operates in the range between 1200-1300° F. Maintaining a clean and properly shaped burner wall helps with air flow that is crucial to generating a flame having a desired shape.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A furnace melt tower, comprising:
a burner block having an inner wall defining a burner port for receiving a burner nozzle; and
a burner tube insert received within the burner port between the inner wall and the burner nozzle.

2. The furnace melt tower of claim 1 wherein the burner tube insert further comprises:
a cylindrical body having a first end and a second end; and
a flange extending radially outward from the first end of the burner tube insert, the flange having a first surface and a second surface.

3. The furnace melt tower of claim 2 wherein the second end of the burner tube insert is frustoconical in shape.

4. The furnace melt tower of claim 3 wherein the first surface of the flange engages an outer wall of the burner block.

5. The furnace melt tower of claim 4 wherein the second surface of the flange engages a portion of the burner nozzle.

6. The furnace melt tower of claim 5 wherein the cylindrical body of the burner tube insert has a gas port.

7. A burner tube insert for use with a port in a burner block of a furnace melt tower, comprising:
a cylindrical body having a first end and a second end; and
a flange extending radially outward from the first end of the burner tube insert, the flange having a first surface and a second surface.

8. The burner tube insert of claim 7 wherein the second end is frustoconical in shape.

9. The burner tube insert of claim 8 wherein the first surface of the flange is engageable with an outer wall of the burner block.

10. The burner tube insert of claim 9 wherein the second surface of the flange is engageable with a portion of a burner nozzle.

11. The burner tube insert of claim 10 wherein the cylindrical body has at least one gas port.

12. The burner tube insert of claim 11 wherein the cylindrical body and the flange are comprised of steel.

13. The burner tube insert of claim 11 wherein the cylindrical body and the flange are comprised of stainless steel.

14. A burner assembly for a furnace, comprising:
a burner block having an inner wall defining a burner port;
a burner nozzle disposed within the burner port; and
a burner tube insert received within the burner port between the inner wall and the burner nozzle.

15. The burner assembly of claim 14 wherein the burner tube insert further comprises:
a cylindrical body having a first end and a second end; and
a flange extending radially outward from the first end of the burner tube insert, the flange having a first surface and a second surface.

16. The burner assembly of claim 15 wherein the second end of the burner tube insert is frustoconical in shape.

17. The burner assembly of claim 16 wherein the first surface of the flange engages an outer wall of the burner block.

18. The burner assembly of claim 17 wherein the second surface of the flange engages a portion of the burner nozzle.

19. The burner assembly of claim 18 wherein the cylindrical body of the burner tube insert has a gas port.

20. The burner assembly of claim 19 wherein the cylindrical body and the flange are comprised of a material selected from the group consisting of steel and stainless steel.
